(19) United States
(12) Patent Application Publication
(10) Pub. No.: US 2026/0077879 A1
(43) Pub. Date: Mar. 19, 2026

(54) FLIGHT HEADING ESTIMATION

(71) Applicant: Rockwell Collins, Inc., Cedar Rapids, IA (US)

(72) Inventors: Carlo L. Tiana, Phoenix, AZ (US); Serena Iovino, Roma (IT); MaryAnn Ho, Superior, CO (US)

(21) Appl. No.: 19/329,974

(22) Filed: Sep. 16, 2025

(30) Foreign Application Priority Data
Sep. 16, 2024 (EP) 24200647.6

(51) Int. Cl. B64D 45/08

(52) U.S. Cl. CPC B64D 45/08

(57) ABSTRACT

An aircraft heading estimation system includes: one or more sensors arranged on the aircraft to detect features in a viewing region and provide feature signals indicative of the detected features; an image processor storing predetermined image information of one or more expected features, being features that might be expected to be present in the viewing region, the image processor configured to compare the features indicated by the feature signals with the one or more expected features to generate an estimated observed image and to derive an estimated heading for the aircraft based on the estimated observed image; where the image processor is further configured to incrementally update the estimated observed image with new feature signals generated by the sensors as their distance to the viewing region changes, and to incrementally updated the estimated heading based on the updated estimate observed image.

### CROSS-REFERENCE TO RELATED APPLICATIONS

The present disclosure claims the benefit of European Patent Application No. 24200647.6, filed Sep. 16, 2024, which is herein incorporated by reference in the entirety.

### TECHNICAL FIELD

The present disclosure is concerned with estimating a flight heading for an aircraft, particularly in poor visibility conditions.

### BACKGROUND

For both manual and autonomous flights, when an aircraft is flying in low visibility conditions, the pilot/flight control system requires accurate heading estimation which requires multiple verification and confirmation procedures. Particularly on approach and landing, if visibility is poor, an aircraft may not be able to receive sufficient information from its sensors or from the approach lighting system of an airport to be able to accurately and safely judge the heading and perform a safe approach and landing. An approach lighting system (ALS) typically displays a series of lights or light bars that flash and/or vary in size along the length of the landing area to guide the pilot. The more the pilot/auto-pilot is not able to accurately detect these lights, the greater the risk of a heading error and, subsequently, erroneous landing.

Aircraft typically rely on high resolution sensors to reliably detect objects to assist in approach and landing. Such high resolution sensors, however, are generally not able to penetrate the atmosphere. Other sensors, which have a long range, do not, on the other hand, have high resolution.

There is a need to provide a system to provide increased accuracy heading estimations in low visibility conditions to assist in safe and reliable approach and landing of an aircraft.

### SUMMARY

According to one aspect, there is provided an aircraft heading estimation system comprising: one or more sensors arranged on the aircraft to detect features in a viewing region and provide feature signals indicative of the detected features; an image processor storing predetermined image information of one or more expected features, being features that might be expected to be present in the viewing region, the image processor configured to compare the features indicated by the feature signals with the one or more expected features to generate an estimated observed image and to derive an estimated heading for the aircraft based on the estimate observed image; wherein the image processor is further configured to incrementally update the estimated observed image with new feature signals generated by the sensors as their distance to the viewing region changes, and to incrementally updated the estimated heading based on the updated estimate observed image.

According to another aspect, there is provided a method of estimating an aircraft heading, comprising: detecting, by one or more sensors arranged on an aircraft, features in a viewing region and providing feature signals indicative of the detected features; comparing, in an image processor, the features indicated by the feature signals with one or more expected features, being features that might be expected to be present in the viewing region, to generate an estimated observed image; deriving an estimated heading for the aircraft based on the estimate observed image; and incrementally updating the estimated observed image with new feature signals generated by the sensors as their distance to the viewing region changes, and incrementally updating the estimated heading based on the updated estimate observed image

### BRIEF DESCRIPTION OF THE DRAWINGS

Examples of the estimation techniques according to this disclosure will now be described with reference to the drawings. It should be noted that these are examples only and that variations are possible within the scope of the claims.

FIG. 1 shows an example of signals returned from an ALS as an aircraft approaches an airport to land, in accordance with one or more embodiments of the present disclosure.

FIG. 2 is a graph showing heading error as a function of the number of ALS bars detected by the aircraft, in accordance with one or more embodiments of the present disclosure.

FIG. 3 is a simplified block diagram of a system for flight heading estimation, in accordance with one or more embodiments of the present disclosure.

FIG. 4 is a flowchart depicting a method (or process) for flight heading estimation, in accordance with one or more embodiments of the present disclosure.

### DETAILED DESCRIPTION

As described in the background, above, aircraft are typically guided on approach and landing by an airport lighting system (ALS) including different lights (or light bars) located at different known points of the approach and landing runway and having a known size and spacing. Based on detection of the sequence of lights/bars, the aircraft can determine and control its heading for safe landing. The ALS can also be used to estimate altitude. In addition, or alternatively, aircraft may use other observed objects and, knowing their position or location, are able to estimate the aircraft heading based on such observations.

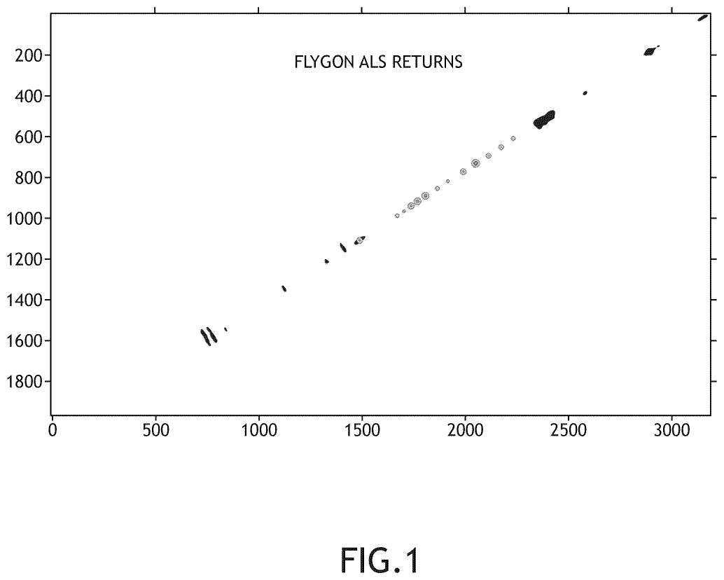

In some conditions, however, the aircraft might not detect all or sufficient lights of the ALS and/or sufficient known objects or features of such objects, to make a reliable estimation of its heading. FIG. 1, for example, shows what parts of the ALS might be detected by an aircraft in a given visibility—which are not all of the ALS light bars. In poor visibility, the aircraft might only ‘see’ some ALS bars or lights, or may only see partial bars and so the aircraft may underestimate their size, or might wrongly identify objects due to not seeing their entire shape or size or features.

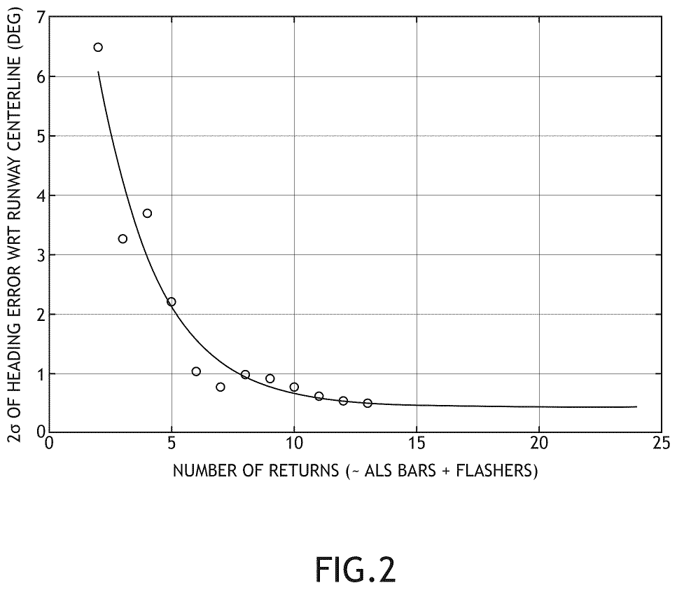

The graph of FIG. 2 shows that for a lower number of ‘returns’, i.e., detection of fewer ALS lights or bars, the likelihood of error in estimating the aircraft heading increases exponentially.

The techniques of this disclosure allow for improved accuracy in estimating the aircraft heading on approach even in low visibility conditions where, when further away from the airport, fewer ALS lights or known objects are visually detected, but the heading estimation is updated incrementally as the aircraft gets closer to the airport based on objects observed or detected by a vision system of the aircraft.

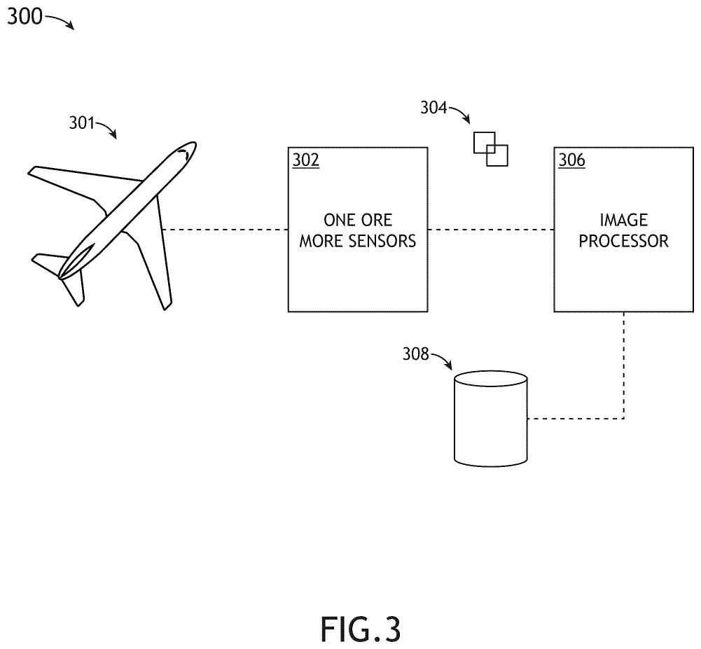

FIG. 3 illustrates a system 300 for flight heading estimation, in accordance with one or more embodiments of the present disclosure.

The system 300 may include one or more sensors arranged on an aircraft 301 to detect features in a viewing region and provide feature signals indicative of the detected features (e.g., lights from the ALS, objects (e.g., building, vehicle, terrain feature, or the like), or the like). For example, the system 300 may include one or more long-range sensors 302 such as radars located on the aircraft 301. For instance, the one or more long-range sensors 302 may be configured to generate one or more images 304 (e.g., visually detected images) associated with the feature signals indicative of the detected features. As mentioned above, the aircraft needs to use such sensors because it needs to be able to detect objects a great distance away due to the aircraft high speeds. Whilst such sensors can penetrate the atmosphere and so visually detect objects a great distance away, they do not provide high resolution images of what they have detected.

The heading estimation technique uses the visually detected images from these long-range sensors as the aircraft approaches. Initially, the images 304 from the sensors 302 will be very unclear, low resolution images and will not provide sufficient information for heading estimation. As the aircraft gets closer to the ground, the sensors will obtain more information from the objects in its range and will provide greater resolution.

The system 300 may include an image processor 306 and a database 308 storing predetermined image information of one or more expected features. For example, the predetermined image information of the database 308 may be associated with features that might be expected to be present in the viewing region. In one instance, the image information includes learned information. In another instance, the image information includes stored information. In another instance, the image information includes pre-programmed information. In another instance, the image processor includes map information.

The image processor 306 may be configured to receive the one or more images 304 from the one or more sensors 302 and compare the images with the database 308 which may include features that have been saved and/or learned as features that might be expected to be present in the viewing range of the system, or features of objects that would be expected in the viewing range. Based on the comparison, the image processor 306 may be configured to use the additional information to estimate and incrementally improve estimation of the aircraft heading. For example, the image processor 306 may generate an estimated observed image and derive an estimated heading for the aircraft 301 based on the estimated observed image generated. In one instance, the image processor 306 may generate the estimated observed image using a process of connecting lines between centroids of detected fuzzy light points. In another instance, the image processor 306 may generate the estimated observed image using a best-fit process.

The image processor 306 may be further configured to incrementally update the estimated observed image with new feature signals generated by the sensors as their distance to the viewing region changes, and to incrementally updated the estimated heading based on the updated estimate observed image.

Using the example of an ALS, initially, when far from the airport, the sensor 302 will only detect light but will not provide sufficient resolution of the detected image to be able to identify the shape, size or spacing of the light sources. An initial estimation of the heading can be made based on expected ALS patterns in the sensor range. The image processor 306 can perform image processing using the obtained information, e.g., by connecting lines between centroids of detected fuzzy light points and/or performing best-fit processing based on expected images to provide an estimate of the heading.

As the aircraft approaches the ground, the sensor 302 returns higher resolution images which provide more information of the detected objects and, again, this information, together with information about objects that the system might expect to observe, can be processed and the heading estimation can be adjusted incrementally as more information is detected from the objects ‘seen’ by the sensor.

The ‘expected’ patterns stored in the database 308 may be known ALS light arrangements and/or may be other objects e.g. buildings or features of terrain.

The system 300 may have stored or pre-programmed or learned ‘expected’ ALS patterns and/or objects stored in the database 308 with which the actual detected images 304 can be compared.

With an initial ‘coarse’ image detection, an estimate can be generated on the aircraft heading by image processing as suggested above, e.g. extrapolation, joining centers, completing lines or shapes based on what, with reference to the ‘expected’ patterns or objects, are realistic expectations for what is actually present in the viewing region. The estimate is incrementally updated so that as the aircraft gets closer to the ground, and produces more clear/sharper images, a correction can be made to the processed image on the basis of which the heading is estimated.

In this way, the aircraft system does not need to wait until the ALS/objects can be clearly observed before making a heading estimation—the header estimation begins while the aircraft is still some distance away from landing and whilst only unclear images are being generated from the sensor. The estimated heading then becomes more accurate and/or can be corrected as more image information is obtained.

By using additional visual information and expected information to incrementally adjust the estimated heading, approach and landing operations in low visibility conditions can be successfully completed more often.

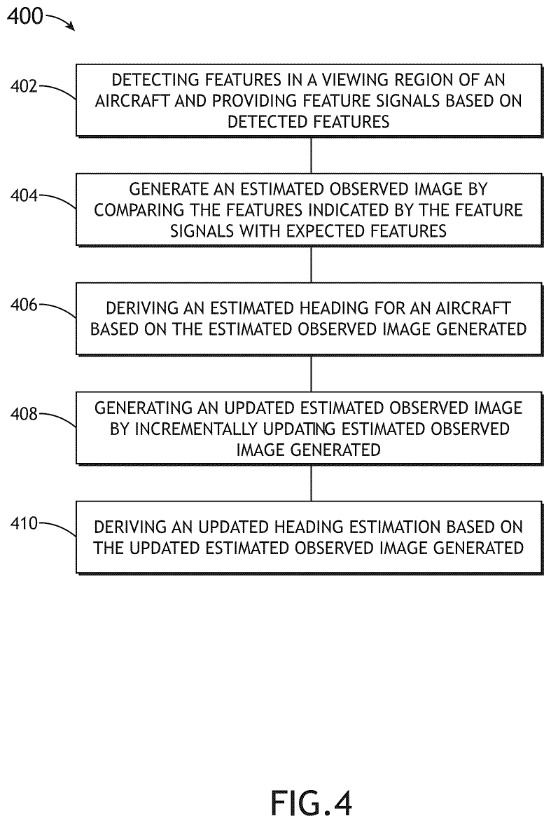

FIG. 4 illustrates a flowchart depicting a method 400 (or process) for flight heading estimation, in accordance with one or more embodiments of the present disclosure.

The method 400 includes a step 402 of detecting, by the one or more sensors 302 arranged on the aircraft, features in a viewing region and providing feature signals indicative of the detected features.

The method 400 includes a step 404 of comparing, in the image processor 306, the features indicated by the feature signals of the images 304 with one or more expected features of the database 308, where the expected features include features that might be expected to be present in the viewing region, to generate an estimated observed image.

The method 400 includes a step 406 of deriving an estimated heading for the aircraft based on the estimated observed image generated.

The method 400 includes a step 408 of incrementally updating the estimated observed image with new feature signals generated by the sensors as their distance to the viewing region changes.

The method 400 includes a step 410 of incrementally updating the estimated heading based on the updated estimated observed image.

1. An aircraft heading estimation system comprising:
one or more sensors arranged on the aircraft to detect one or more features in a viewing region and provide one or more feature signals indicative of the one or more features detected;
an image processor storing predetermined image information of one or more expected features, wherein the one or more expected features include features that might be expected to be present in the viewing region,
the image processor configured to compare the one or more features indicated by the one or more feature signals with the one or more expected features to generate an estimated observed image and to derive an estimated heading for the aircraft based on the estimated observed image generated;
wherein the image processor is further configured to incrementally update the estimated observed image generated with new feature signals generated by the one or more sensors as a distance between the one or more sensors and the viewing region changes, and to incrementally updated the estimated heading based on the updated estimated observed image generated.

2. The system of claim 1, wherein the one or more sensors comprise one or more long-range sensors.

3. The system of claim 1, wherein the one or more features comprise one or more lights from an aircraft landing system.

4. The system of claim 1, wherein the one or more features comprises one or more objects.

5. The system of claim 4, wherein the one or more objects include a building, a vehicle, or a feature of terrain.

6. The system of claim 1, wherein the image processor uses a process of connecting lines between centroids of detected fuzzy light points to generate the estimated observed image.

7. The system of claim 1, wherein the image processor uses a best-fit process to generate the estimated observed image.

8. The system of claim 1, wherein the predetermined image information comprises learned information.

9. The system of claim 1, wherein the predetermined image information comprises stored information.

10. The system of claim 1, wherein the predetermined image information comprises pre-programmed information.

11. The system of claim 1, wherein the predetermined image information comprises map information.

12. A method of estimating an aircraft heading, comprising:
detecting, by one or more sensors arranged on an aircraft, one or more features in a viewing region;
providing feature signals indicative of the one or more features detected;
generating an estimated observed image by comparing, in an image processor, the features indicated by the feature signals with one or more expected features, wherein the one or more expected features include features that might be expected to be present in the viewing region;
deriving an estimated heading for the aircraft based on the estimate observed image generated; and
generating an updated estimated observed image by incrementally updating the estimated observed image generated with new feature signals generated by the one or more sensors as a distance between the aircraft and the viewing region changes; and
deriving an updated estimated heading by incrementally updating the estimated heading derived based on the updated estimate observed image generated.
